(19) United States
(12) Patent Application Publication
(10) Pub. No.: US 2015/0186967 A1
(43) Pub. Date: Jul. 2, 2015

(54) AUTOMATED CUSTOM DESIGN OF DRAPERIES AND CURTAINS

(71) Applicant: Regal Drapes, LLC, Livingston, NJ (US)

(72) Inventors: Opendra Nishan Madawala, Chester, NJ (US); Viktoria Levin, Livingston, NJ (US)

(73) Assignee: REGAL DRAPES, LLC, Livingston, NJ (US)

(21) Appl. No.: 14/144,457

(22) Filed: Dec. 30, 2013

(51) Int. Cl. G06Q 30/06

(52) U.S. Cl. CPC G06Q 30/0621; G06Q 30/0643

(57) ABSTRACT

In a system and method of automated custom design of draperies or curtains, a client computerized device accesses a server computer through the internet, the server computer providing a design tool for designing draperies or curtains. The design tool causes an image of a room is caused to be displayed at the client computerized device. At the client computerized device, a location is selected on the image of the room at which a window or door is to be displayed. The design tool causes the window or door to be displayed on the image of the room at the client computerized device at the selected location. At the client computerized device, a drapery or curtain is selected to be displayed on the image of the room. The design tool causes the selected drapery or curtain to be displayed on the image of the room at the client computerized device in conjunction with the window or door.

### TECHNICAL FIELD

The field of the invention generally relates to automated custom design of drapery and curtains, and more particularly to a design tool that allows a consumer using a computerized device to view how a particular drapery or curtain will appear in a particular setting, including specific room dimensions and colors, specific window locations and dimensions, and/or other aspects of the environment in which the drapery or curtain is to be placed.

### BACKGROUND

The traditional process of selecting drapery or curtains, particularly for a home environment, involves travel to a store to view different types of drapery or curtains, having different styles, fabrics, and colors, and determining which style, fabric, and color will be best suited for a particular window or door of a particular room. The consumer might bring a sample of wallpaper or paint color to the store to help determine which type of drapery or curtain is appropriate, or the consumer might rely on memory of the particular environment in making the determination of which type and fabric of drapery or curtain is appropriate. The consumer also typically brings to the store measurements of window dimensions and the height of the window from the floor, in order to determine the appropriate dimensions of the drapery or curtain to be purchased. Once all the data is assembled, a price can then be figured based on the type of drapery or curtain selected, the fabric selected by the consumer, and the dimensions selected by the consumer.

Alternatively, a consumer may obtain draperies or curtains by visiting a website hosted by a company in the business of selling draperies or curtains, viewing different types of draperies or curtains online through the website, determining which type of drapery or curtain might be best suited for a particular window or door of a particular room, and ordering the drapery or curtain.

It is an object of the invention to provide improved automated custom design of drapery and curtains, and it is a further object of the invention that the improved automated custom design enable a consumer to view with detailed specificity how a particular drapery or curtain will appear in a particular setting before the consumer orders the drapery or curtain.

### SUMMARY

The invention provides a system and method of automated custom design of draperies or curtains. A client computerized device accesses a server computer through the internet, the server computer providing a design tool for designing draperies or curtains. The design tool causes an image of a room to be displayed at the client computerized device. At the client computerized device, a location is selected on the image of the room at which a window or door is to be displayed. The design tool causes the window or door to be displayed on the image of the room at the client computerized device at the selected location. At the client computerized device, a drapery or curtain is selected to be displayed on the image of the room. The design tool causes the selected drapery or curtain to be displayed on the image of the room at the client computerized device in conjunction with the window or door.

Because the design tool causes the window or door to be displayed on the image of the room at a location selected by a consumer, and causes the drapery or curtain selected by the consumer to be displayed on the image of the room in conjunction with the window or door, the consumer can readily see, rather than imagine, what the particular selected drapery or curtain will look like in the particular environment of the specific window location in the room.

In certain embodiments of the invention, the design tool auto-prices the drapery or curtain based on the selected drapery or curtain and the selected location at which the window or door is to be displayed. This feature makes it possible for the consumer to receive pricing information in real time in conjunction with a realistic visual representation of the consumer's room with a particular drapery or curtain, and makes it possible for the consumer to make changes to the consumer's selections and receive instantaneous real-time price change information corresponding to the changes.

In various embodiments of the invention, at the client computerized device, dimensions of the room are selected, and the design tool scales the window or door and the drapery or curtain in the image of the room displayed at the client computerized device in accordance with the selected dimensions of the room. The design tool causes the drapery or curtain to be displayed on the image of the room in conjunction with the window or door with a pattern of the drapery or curtain scaled in accordance with the selected dimensions of the room. The design tool causes the image of the room to be displayed at the client computerized device with user-selectable text boxes containing dimensions so as to enable a user of the client computerized device to select dimensions by keying the dimensions directly into the image of the room displayed at the client computerized device.

At the client computerized device, a color of at least one of a wall, ceiling, floor, or molding of the room is selected, and the design tool causes the image of the room displayed at the client computerized device to be colored in accordance with the selected color. At the client computerized device, a selection is made whether the image of the room includes a molding, and the design tool causes the molding to be included or excluded in the image of the room displayed at the client computerized device in accordance with the selecting at the client computerized device of whether the image of the room includes the molding. At the client computerized device, a dimension of the molding of the room is selected, and the design tool scales, on the image of the room displayed at the client computerized device, the molding in accordance with the selected dimension of the molding.

The design tool causes the client computerized device to display a menu of different types of windows or doors, and, at the client computerized device, a window or door is selected from the menu, and the window or door displayed on the image of the room at the client computerized device at the selected location is the selected window or door. At the client computerized device, dimensions of the window or door may be selected, and the design tool scales the window or door in the image of the room at the client computerized device in accordance with the selected dimensions of the window or door. At the client computerized device, a repositioned location may be selected of a window or door in the image of the room, and the design tool repositions the window or door in the image of the room at the client computerized device in accordance with the repositioned location of the window or door. The design tool enables a user of the client computerized device to resize the window or door by dragging and dropping an edge of the window or door on the image of the room displayed at the client computerized device. At the client computerized device, a window or door may be selected for removal from the image of the room, and the design tool causes the window or door to be removed from the image of the room at the client computerized device at the selected location. The design tool causes the client computerized device to display a menu of different types background images to be seen through the window or door displayed on the image of the room at the client computerized device, and, at the client computerized device, a background image is selected from the menu, and the window or door is displayed on the image of the room at the client computerized device together with the selected background image.

The design tool causes a change in lighting within the image of the room at the client computerized device when the window or door is added to the image of the room at the client computerized device at the selected location, the change in lighting corresponding to passage of light through the window or door. Also, the design tool causes a change in lighting within the image of the room at the client computerized device to change when the drapery or curtain is added to the image of the room in conjunction with the window or door, the change in lighting corresponding to blockage of light by the drapery or curtain.

The design tool causes the drapery or curtain to be displayed on the image of the room at the client computerized device in conjunction with the window or door with dimensions of the drapery or curtain auto-sized based on the selected location of the window or door and dimensions of the window or door and the room. At the client computerized device, a value may be selected of at least one dimension of the drapery or curtain, and the design tool causes the drapery or curtain to be displayed with the selected value of the dimension on the image of the room at the client computerized device. At the client computerized device, an altered value may be re-selected of the at least one dimension of the drapery or curtain, the re-selected altered value being different from the selected value, and the design tool causes the drapery or curtain to be displayed with the re-selected altered value of the dimension on the image of the room at the client computerized device.

The drapery or curtain may include a left portion and a right portion, and, at the client computerized device, one of the left and right portions may be selected for removal from the image of the room at the client computerized device, and the design tool causes the image of the room to be displayed at the client computerized device with the selected portion of the drapery or curtain removed from the image of the room.

The design tool causes hardware for hanging the drapery or curtain to be displayed in conjunction with the drapery or curtain on the image of the room at the client computerized device. The design tool causes the hardware for hanging the drapery or curtain to be scaled in accordance with dimensions of the image of the room. At the client computerized device, a width may be selected of the hardware for hanging the drapery or curtain, and the design tool causes the hardware to be displayed with the selected width on the image of the room at the client computerized device. The design tool auto-prices the drapery or curtain and the hardware based on the selected drapery or curtain, the selected location at which the window or door is to be displayed, and the selected width of the hardware. The design tool causes the client computerized device to display a menu of different types of hardware for hanging the drapery or curtain, and, at the client computerized device, one of the different types of hardware may be selected from the menu, and the design tool causes the selected hardware to be displayed in conjunction with the drapery or curtain on the image of the room at the client computerized device. At the client computerized device, a selection may be made whether an auto-pricing for the drapery or curtain includes hardware for hanging the drapery or curtain, and the design tool auto-prices the drapery or curtain and includes or excludes the hardware from the auto-pricing in accordance with the selecting at the client computerized device of whether the auto-pricing for the drapery or curtain includes the hardware.

At the client computerized device, a dimension may be selected of at least one border of the drapery or curtain, and the design tool causes the border of the drapery or curtain to be displayed with the selected dimension on the image of the room displayed at the client computerized device. At the client computerized device, a fabric may be selected of at least one border of the drapery or curtain, and the design tool causes the border of the drapery or curtain to be displayed with the selected fabric on the image of the room displayed at the client computerized device. At the client computerized device, a request may be made that sheer drapery be added to the image of the room displayed at the client computerized device, and the design tool causes the sheer drapery to be added to the image of the room displayed at the client computerized device.

The design tool provides a summary of parts required for installation of the drapery or curtain and provides sizes of the parts. At the client computerized device, a request may be made that the image of the room with the drapery or curtain be saved, and the design tool saves the image of the room with the drapery or curtain, and, at the client computerized device, the image of the room with the drapery or curtain may be retrieved. At the client computerized device, a purchase of the drapery or curtain may be requested, and the design tool initiates an online purchase of the drapery or curtain.

The details of various embodiments of the invention are set forth in the accompanying drawings and the description below. Numerous other features and advantages of the invention will be apparent from the description, the drawings, and the claims.

### DESCRIPTION OF THE DRAWINGS

FIG. 1 is a schematic drawings of a client computerized device connected over the internet to a server computer that provides a design tool for designing draperies or curtains.

FIGS. 2A-2C are a flowchart diagram of the operation of the design tool of FIG. 1.

FIGS. 3-19 through are screen displays of room images and menus that the design tool of FIG. 1 causes to be displayed on the client computerized device of FIG. 1.

### DETAILED DESCRIPTION

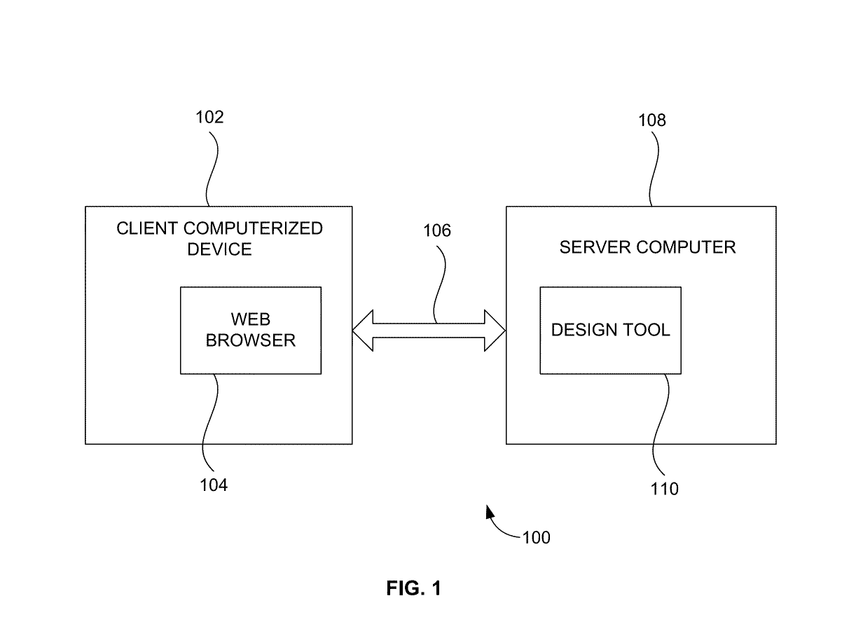

With reference to FIG. 1, in an automated custom design system 100 according to the invention, a client computerized device 102, operated by a consumer, includes a web browser 104 that connects over the internet 106 with a website hosted by a server computer 108 that provides access to a design tool 110 for designing draperies or curtains. As used in this specification and claims, “computerized device” includes computers, such as is shown in FIG. 1, as well as portable computerized devices such as tablet computers, internet tablets, smartphones, and other devices. Furthermore, as used in this specification and claims, “design tool” includes computer programs such as client-side scripts embedded in HTML or XHTML documents, external client-side scripts stored in a file on a computerized device, or server-side scripts stored at the server computer, the scripts or programs being stored in random access memory, hard disks, or other non-transitory, tangible, machine-readable storage media as opposed to transmission media.

A consumer accesses design tool 110 by using web browser 104 at client computerized device 102 to access the appropriate website hosted by server computer 108, which website might include a variety of selectable webpages describing current collections of draperies and curtains, details of their manufacture and product features, shipping information, company information, etc., as well as a link to the “design tool” 110 that can be selected by the costumer operating client computerized device 102 by using a mouse to click at the appropriate location on the website or by using any analogous selection method. Once the consumer has selected design tool 110, the design tool is automatically loaded onto client computerized device 102 so that it may operate independently of internet connection 106 between client computerized device 102 and server computer 108.

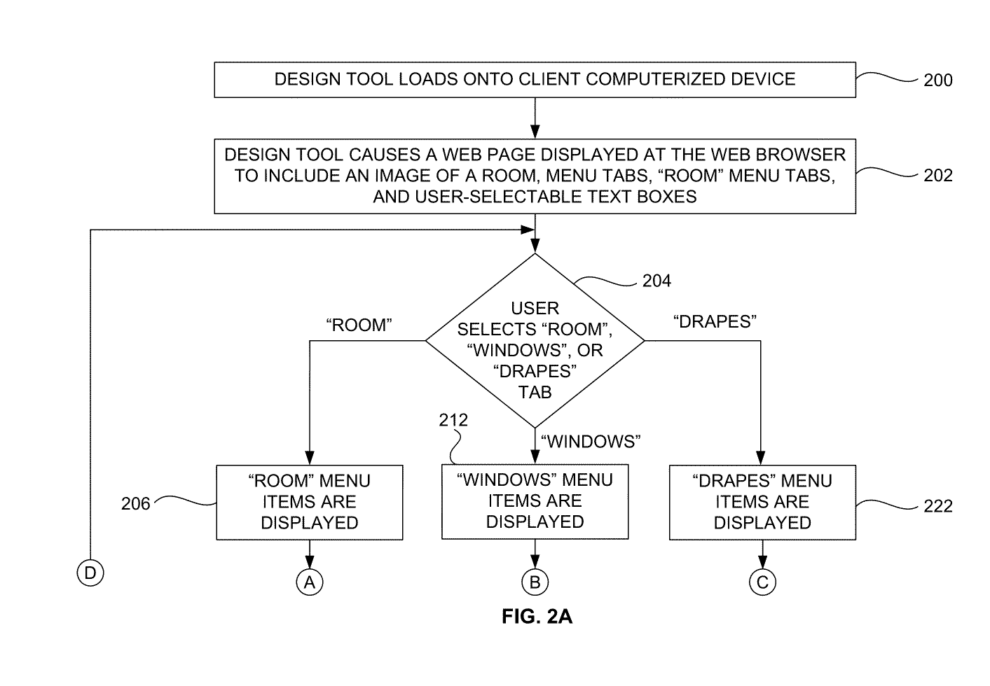

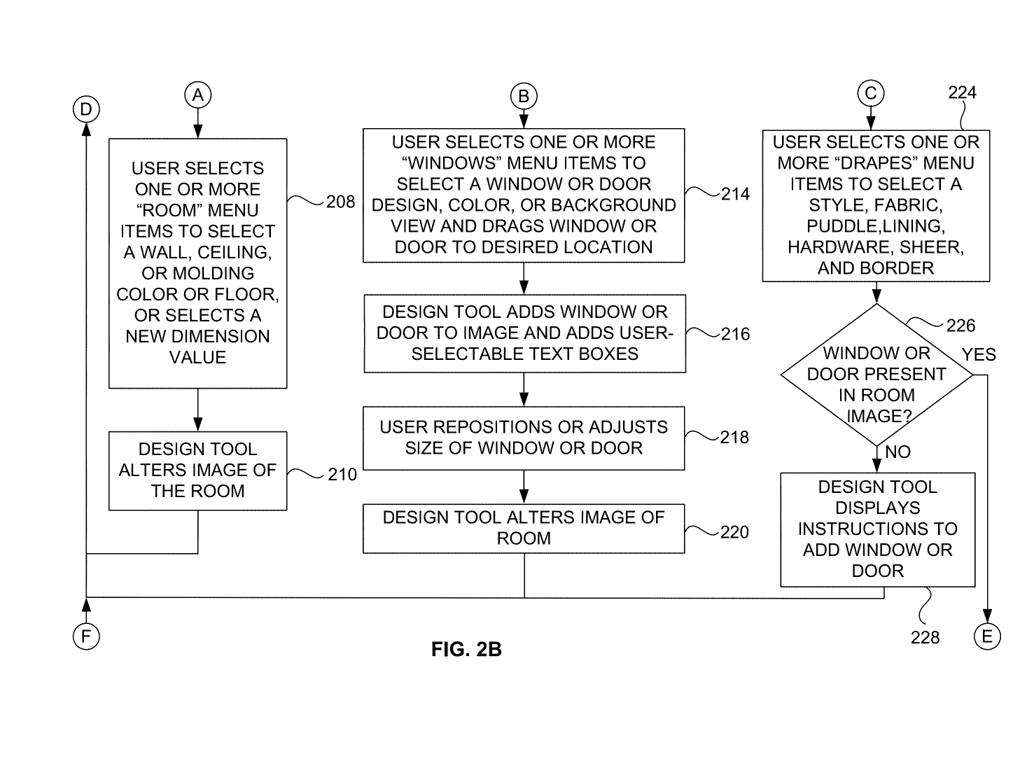

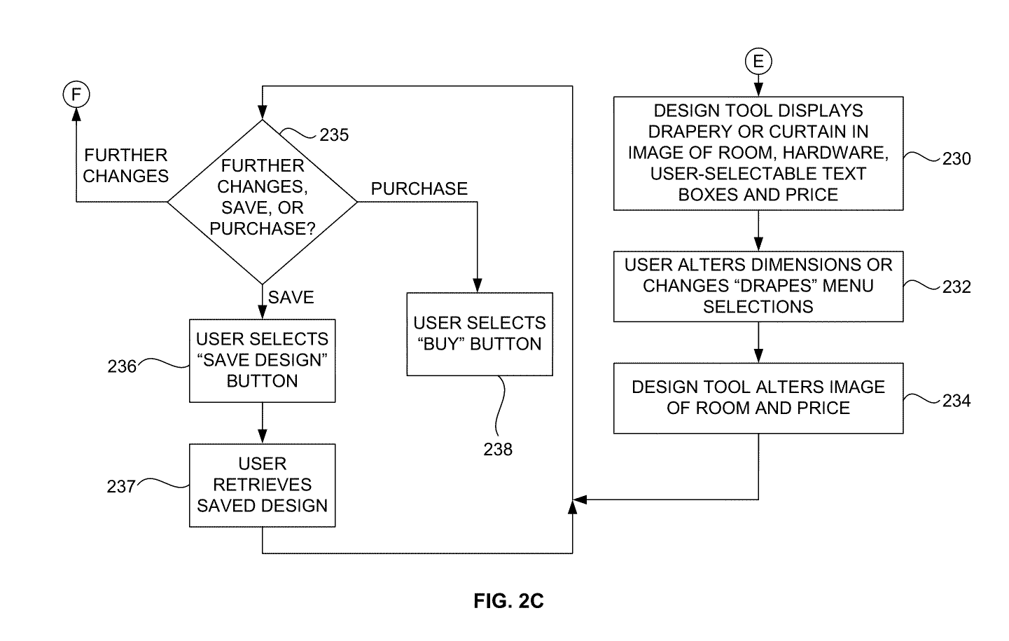

With reference to FIGS. 2A-2C, which detail a flowchart of operation of the design tool, once the design tool has been loaded onto the client computerized device (step 200), the design tool causes a web page displayed in the web browser of the client computerized device to include an image of a room (step 202), with pre-set values of height and width of the room, pre-set wall color, floor, and ceiling color, and pre-set top and bottom molding heights and colors. Also displayed on the web page in step 202 is a set of three menu tabs: a “room” tab, and “windows” tab,” and a “drapes” tab, with the “room” tab automatically selected and “room” menu items displayed that enable the consumer to choose different wall colors, different floors, different ceiling colors, and different molding colors. Thus, the “room” tab is the default tab that is selected when the design tool is opened. Step 202 also includes display of user-selectable text boxes on the image of the room on the web page, the text boxes containing dimensions for the height and width of the room and the height of the top and bottom moldings, so as to enable a user of the client computerized device to select dimensions by keying the dimensions directly into the text boxes.

In step 204, the consumer either continues with the “room” tab automatically selected, or selects the “windows” tab or the “drapes” tab by using a mouse to click on the tab in the page displayed by the web browser at the client computerized device, or by using any analogous selection method. If the “room” tab remains selected, the set of “room” menu items remains displayed (step 206), and the consumer may select one or more “room” menu items to choose a different wall color, a different floor, a different ceiling color, or a different molding color, and might use one or more of the key boxes to select a different dimension for the height or width of the room or the height of the top or bottom moldings (step 208). The design tool then alters the image of the room displayed within the web page on the client computerized device according to the changes initiated by the consumer (step 210).

If, in step 204, the consumer selects the “windows” tab, a set of “windows” menu items is displayed (step 212), and the consumer may select one or more “windows” menu items to choose among different window or door designs, different window or door colors, and different background views to be seen through the windows or doors, and the consumer may drag at least one selected window or door onto a desired location on the image of the room displayed on the web page, by dragging with a computer mouse or by any analogous method (step 214). The design tool then alters the image of the room to include the selected window or door, along with user-selectable text boxes indicating the height and width of the window or door as well as the distance between the window and door and the floor and the left wall of the room (step 216). The user may then drag the window or door within the image to reposition it, or may key in different measurements into the text boxes, or may adjust the size of the window by dragging the right or bottom edge of the window (step 218) and the design tool alters the image of the room according to the changes initiated by the consumer (step 220).

If, in step 204, the consumer selects the “drapes” tab, a set of “drapes” menu items is displayed (step 222), and the consumer may select one or more “drapes” menu items to choose among different drapery or curtain styles and fabrics, puddle or no puddle options, different lining options, hardware or no hardware purchase options and different types of hardware, sheer or no sheer options and different sheer fabric options, and different top and bottom border fabrics (step 224). If, in step 224, the consumer selects a drapery or curtain style or fabric before a window or door has been added to the image of the room (step 226), the design tool causes the web browser to display instructions to the consumer (step 228) to go to the “windows” tab first, choose a window or door, and drag the window or door onto the image of the room. If the image of the room already includes a window or door, then the design tool displays the selected drapery or curtain in conjunction with the window or door, along with mounting hardware, and user-selectable text boxes containing auto-selected heights and widths of the drapery or curtain panels, distances between the mounting hardware and the ceiling and the top of the window or door, and an auto-selected width of the mounting hardware (step 230). Also, in step 230, the design tool causes a price to be displayed on the web page that corresponds to the cost of the specific drapery or curtain, and the specific hardware if selected by the consumer, at the particular dimensions selected by the consumer for the drapery or curtain, the hardware. The consumer may alter any of these dimensions, or may change any of the selections from the “drapes” menu (step 232), and the design tool alters the image of the room according to the changes initiated by the consumer and alters the displayed price if the changes initiated by the consumer affect the total price (step 234). The displayed price is also dependent on the drapery or curtain styles and fabrics, puddle or no puddle options, the lining options, the sheer or no sheer options and different sheer fabric options, and the different top and bottom border fabrics and dimensions.

Next (step 235), the consumer may go back to step 204 to make further changes using either the “room,” “windows” or “drapes” tab, or may save the design by selecting a “save design” button on the web page (step 236) and later retrieve the saved design (step 237), or the consumer may initiate an online purchase of the drapery or curtain, and the mounting hardware if selected by the consumer, by selecting a “buy” button on the web page (238).

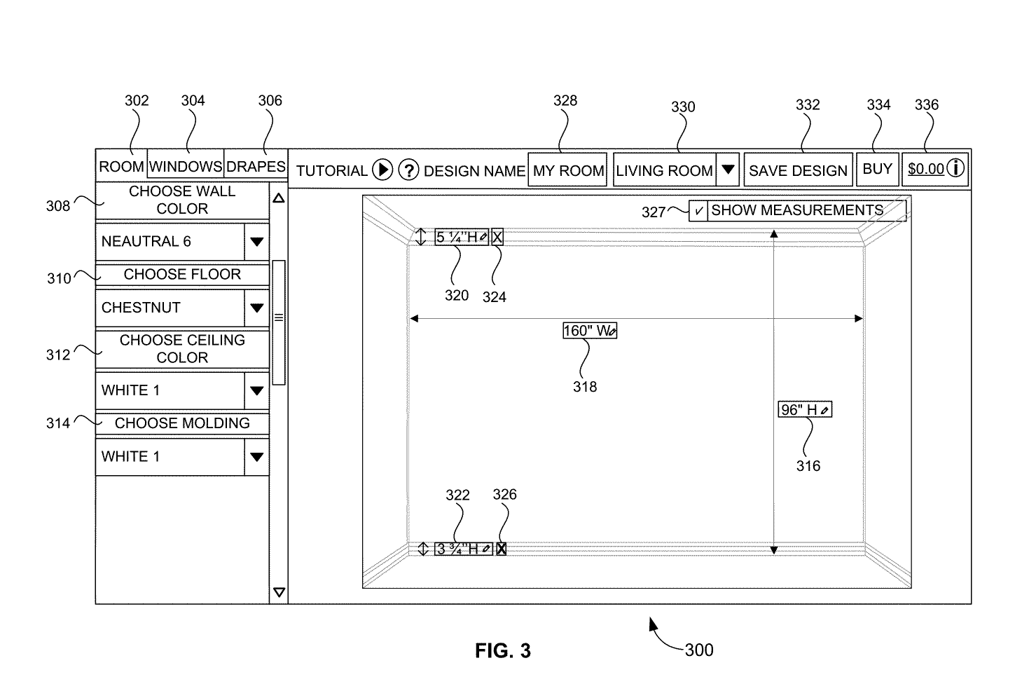

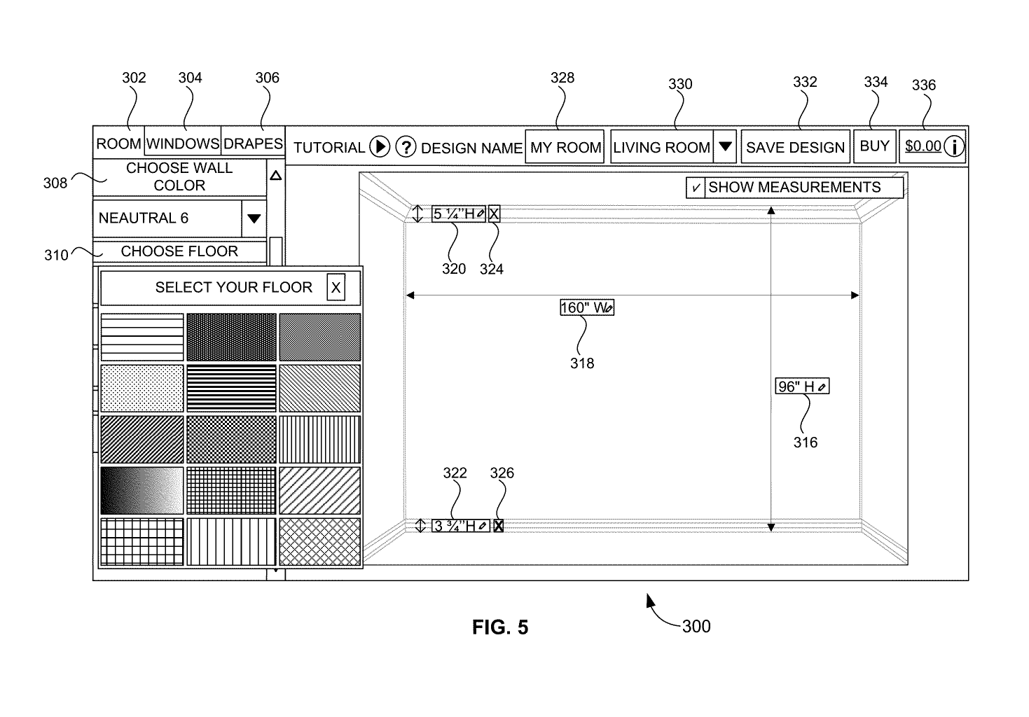

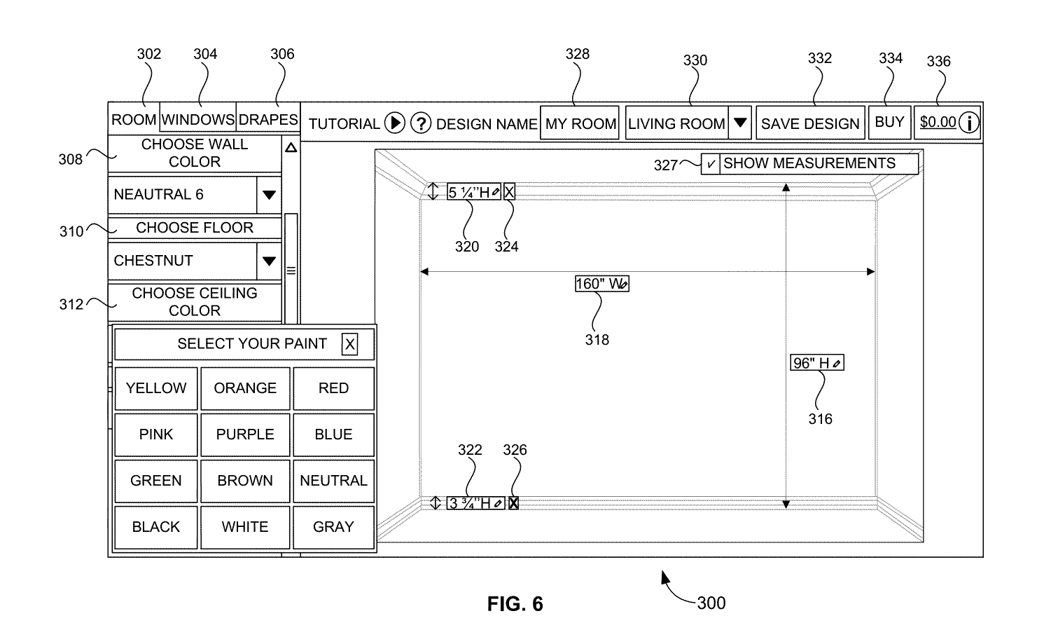

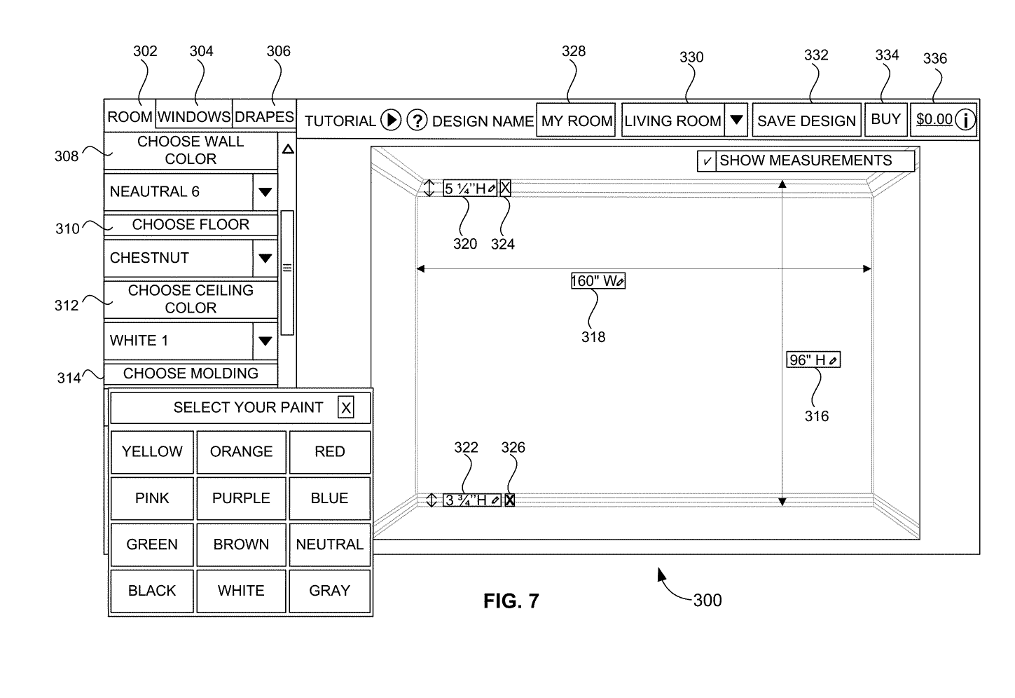

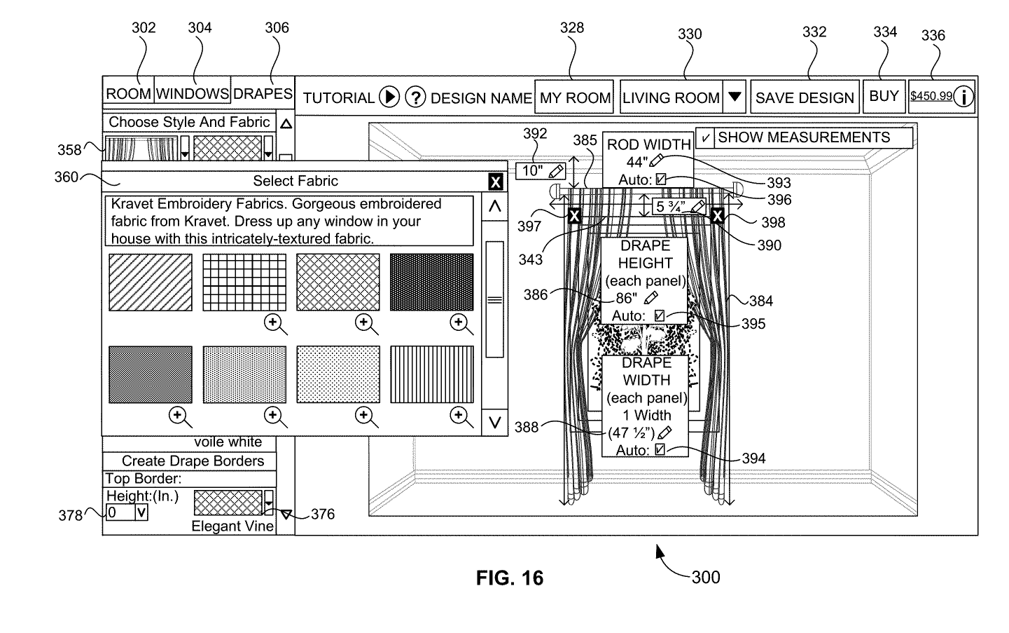

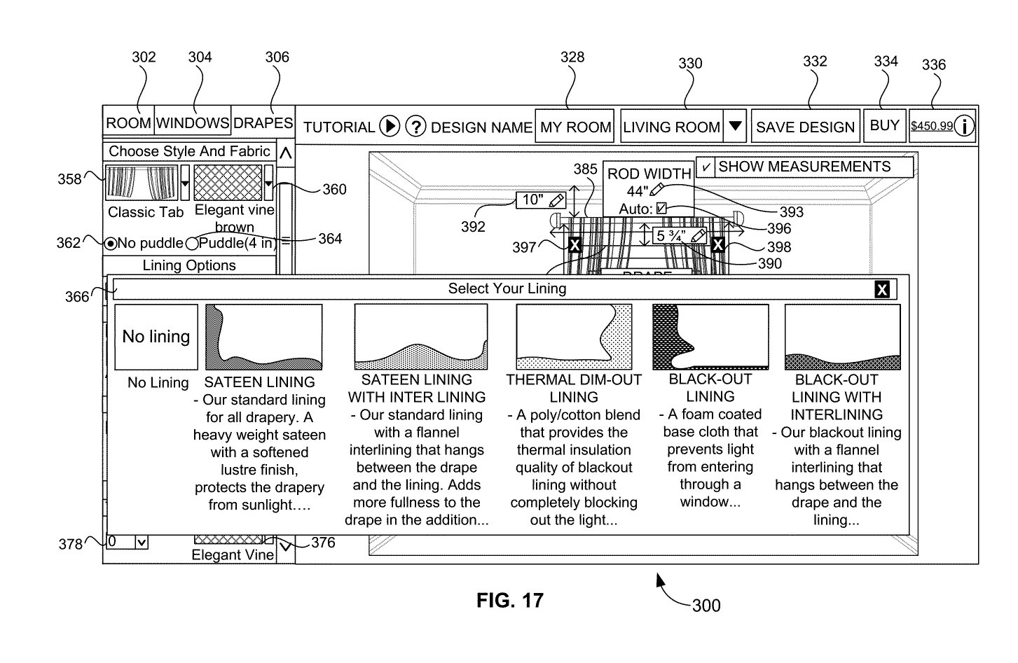

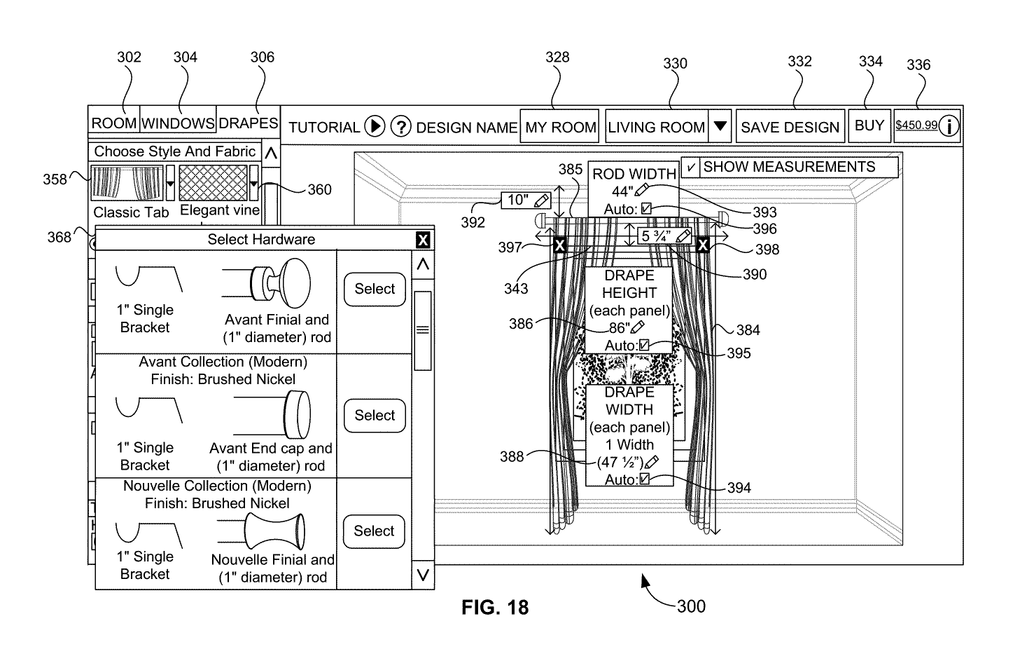

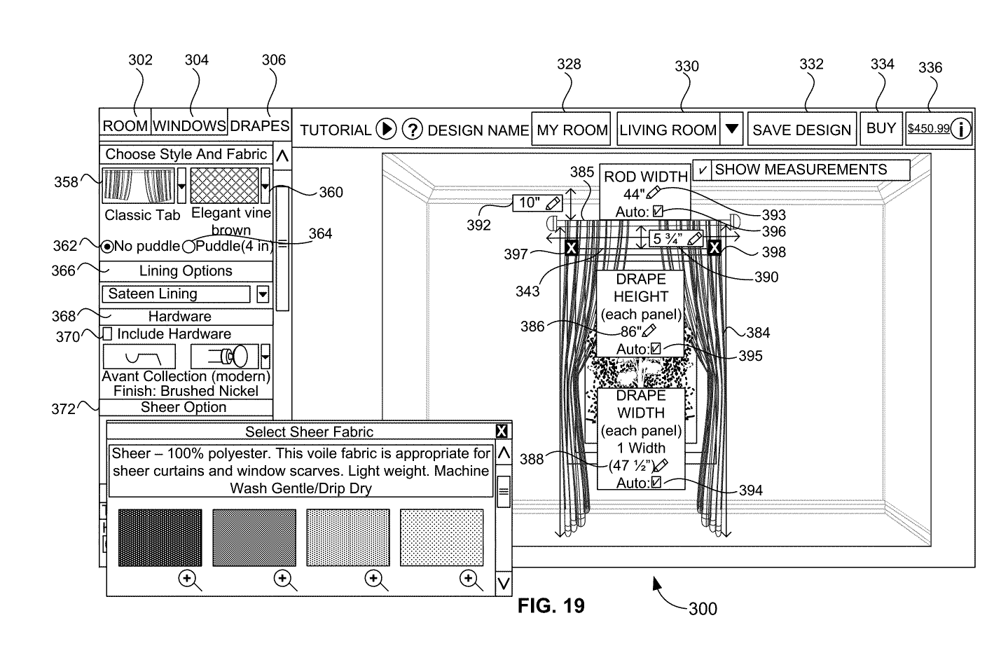

With reference to FIGS. 3-20, there are shown screen displays of room images and menus that the design tool of causes to be displayed on the client computerized device. FIG. 3 illustrates the initial image of the room 300, “room” menu tab 302, “windows” menu tab 304, and “drapes” menu tab 306. Also shown are a “wall color” menu item 308, “floor” menu item 310, “ceiling color” menu item 312, and “molding” menu item 314. Displayed on the image of the room 300 are user-selectable text boxes 316, 318, 320, and 322 containing dimensions for the height and width of the room and the height of the top and bottom moldings respectively. “X” boxes 324 and 326 allow the consumer to remove the top or bottom molding, respectively from the image of the room 300. A “show measurements” checkbox 327 allows the consumer to include or remove measurements from the visual display, removal of measurements being helpful for enabling proper visualization of the drapery or curtain within the room environment. The consumer may store a design name in design name box 328 and may identify the type of room (such as living room, dining room, family room, etc. using drop-down menu 330. Also shown are “save design” button 332, “buy” button 334, and total price box 336.

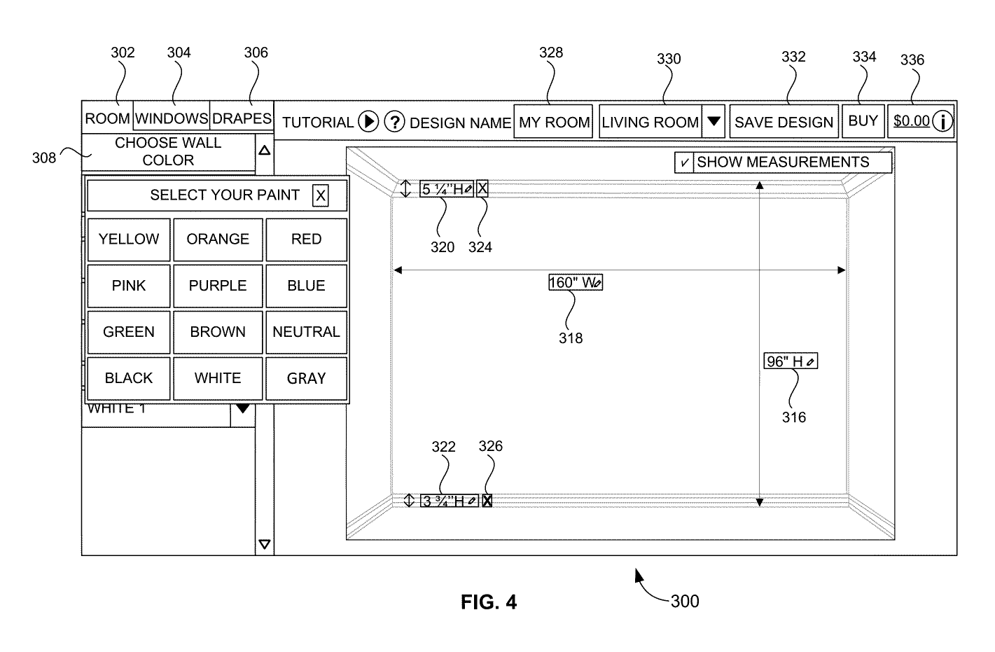

FIGS. 4-7 illustrate screen displays when the consumer selects menu items 308, 310, 312, and 314, respectively. When one of menu items 308, 310, 312, and 314 is selected, the menu item appears in an expanded form, with samples of the various colors or floors being illustrated so that the consumer can select a desired color or floor.

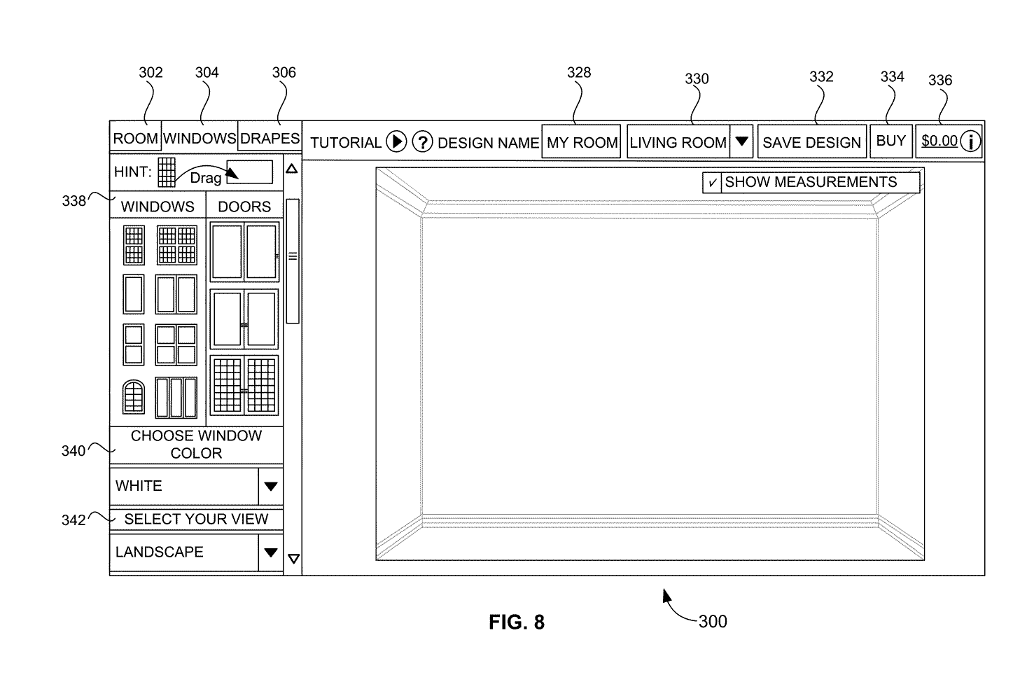

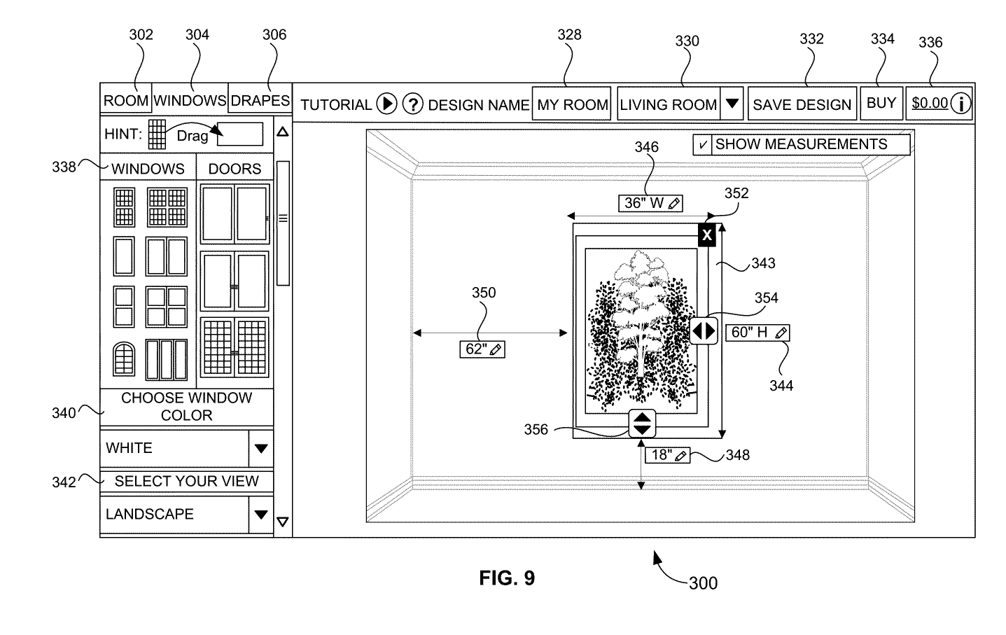

FIG. 8 illustrates a screen display when the consumer selects “windows” menu tab 304. Shown are a “windows and doors” menu item 338, “window color” menu item 340, and “select your view” menu item 342. FIG. 9 illustrates the screen display once the consumer has dragged a window 343 from “windows and doors” menu item onto a desired location in the image of the room. The design tool adjusts the lighting within the image of the room according to reflect the presence of light passing through window 343. User-selectable text boxes 344, 346, 348, and 350 respectively indicate the height and width of the window or door as well, as the distance between the window or door and the floor, and the distance between the window or door and the left wall of the room (step 216). “X” box 352 allows the consumer to remove the window from the image of the room, and slider boxes 354 and 356 allow the consumer to adjust the size of the window by dragging the right or bottom edge of the window, respectively.

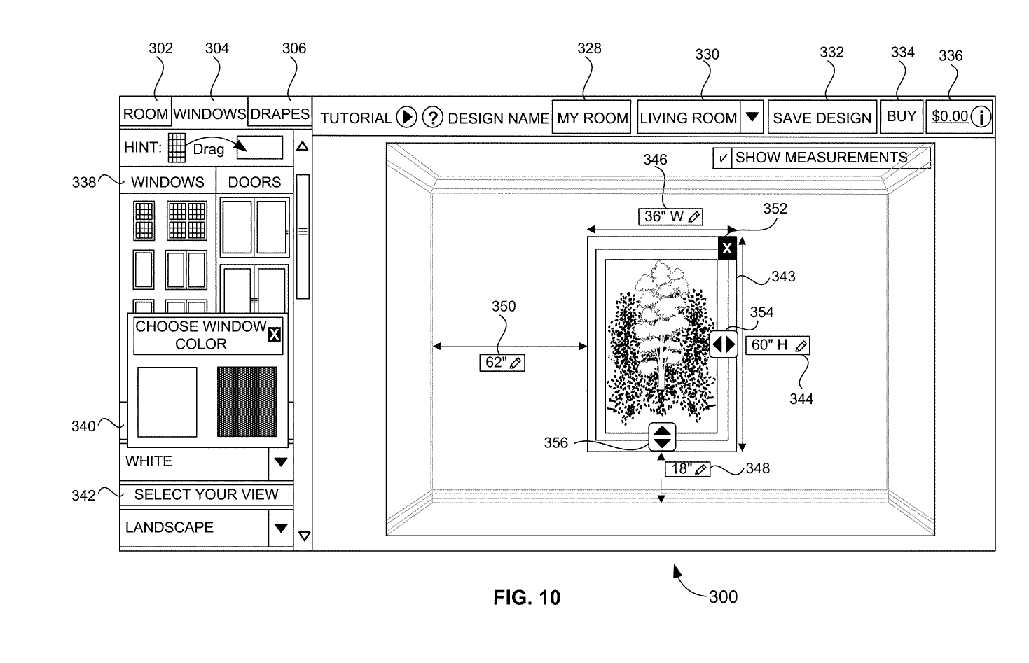

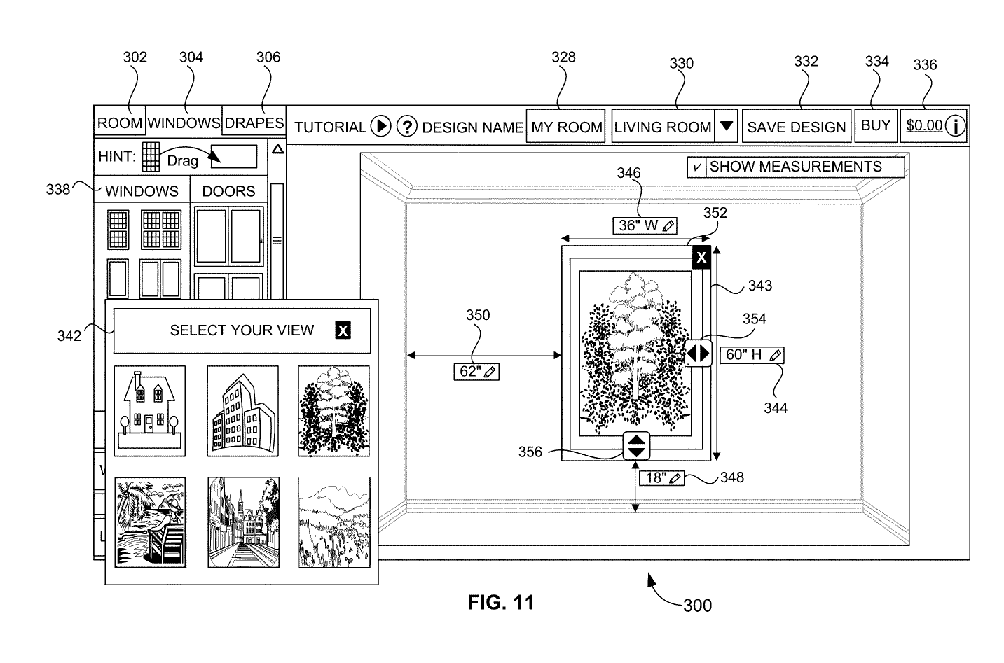

FIGS. 10 and 11 illustrate screen displays when the consumer selects menu items 338 and 340, respectively. When one of menu items 338 and 340 is selected, the menu item appears in an expanded form, with samples of the various window colors or background views being illustrated so that the consumer can select a desired color or background view.

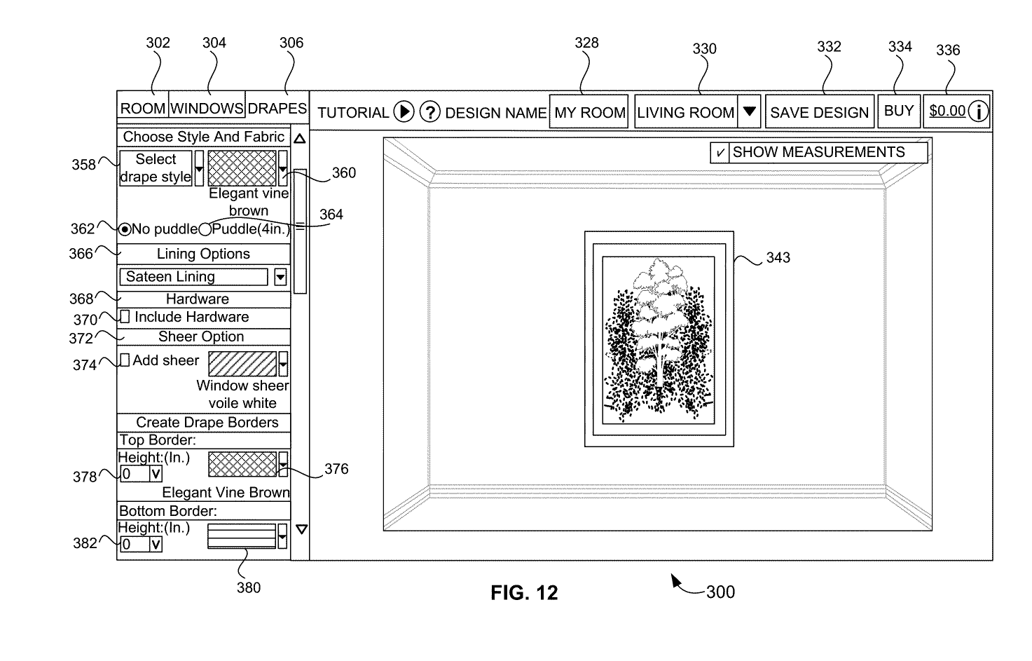

FIG. 12 illustrates a screen display when the consumer selects “drapes” menu tab 306. Shown are a “style” menu item 358, “fabric” menu item 360, “no puddle” and “puddle” selection circles 362 and 364, “lining options” menu item 366, “hardware” menu item 368 along with “include hardware” selection box 370, “sheer option” menu item 372 along with “add sheer” selection box 374, “top border” menu item 376 along with drop-down height menu item 378, and “bottom border” menu item 380 along with drop-down height menu item 382.

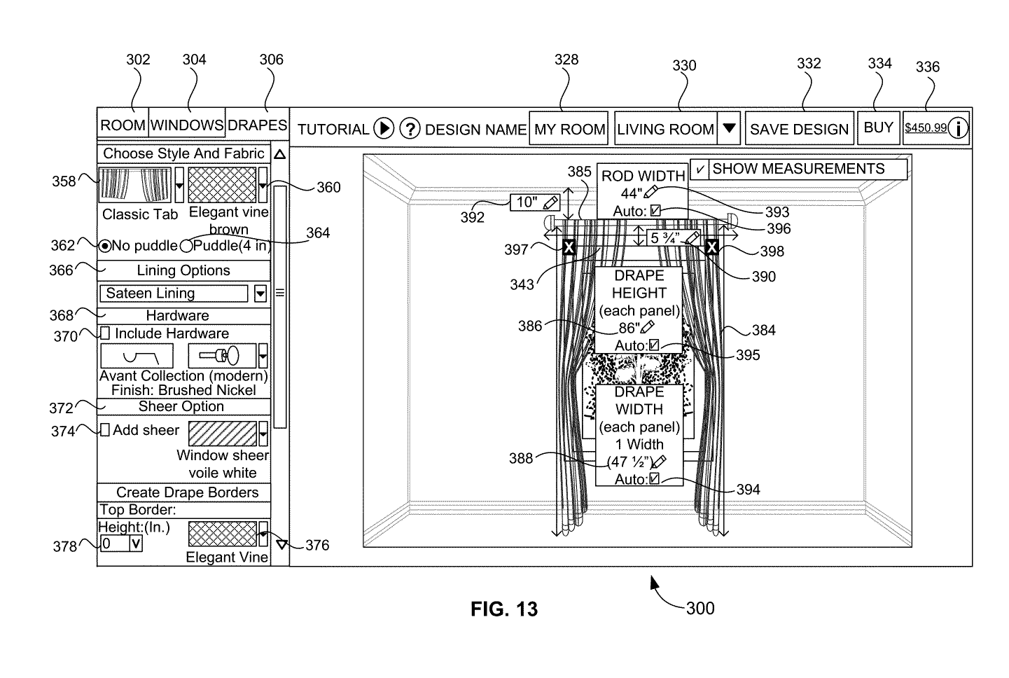

FIG. 13 illustrates the screen display once the consumer has selected a drapery or curtain style from “style” menu item 358. The design tool adds the drapery or curtain 384 to the image of the room, along with the selected mounting hardware including mounting rod 385, and adjusts the lighting within the image of the room according to reflect blockage of light passing through window 343 by drapery or curtain 384. User-selectable text boxes 386, 388, 390, 392, and 393 respectively indicate the height and width of each panel of drapery or curtain 384, the distance between mounting rod 385 and the top of window 343, the distance between mounting rod 385 and the ceiling, and the width of the mounting rod. “Auto” check boxes 394, 395, and 396 respectively allow the consumer to enable or disable auto-sizing of the width and height of the drapery or curtain panels and of the width of mounting rod 385. “X” boxes 397 and 398 allow the consumer to remove selectively either the left or the right panel, or both panels, of the drapery or curtain from the image of the room.

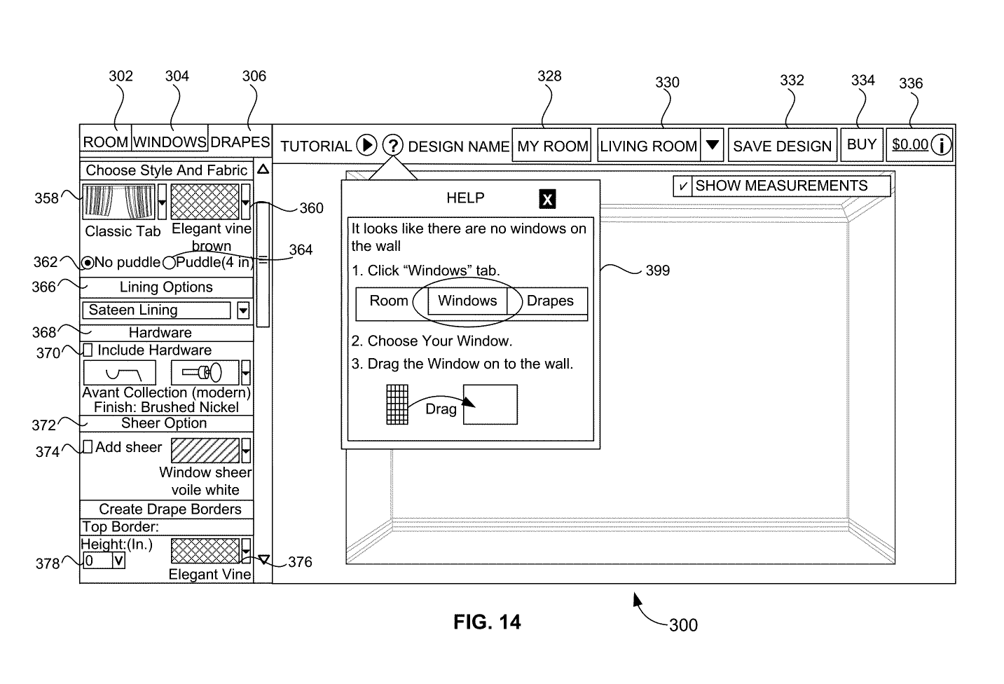

FIG. 14 illustrates the screen display when a consumer has selected a drapery or curtain style before a window or door has been dragged onto the image of the room. A help box 399 instructs the consumer to go to the “windows” tab first, choose a window or door, and drag the window or door onto the image of the room.

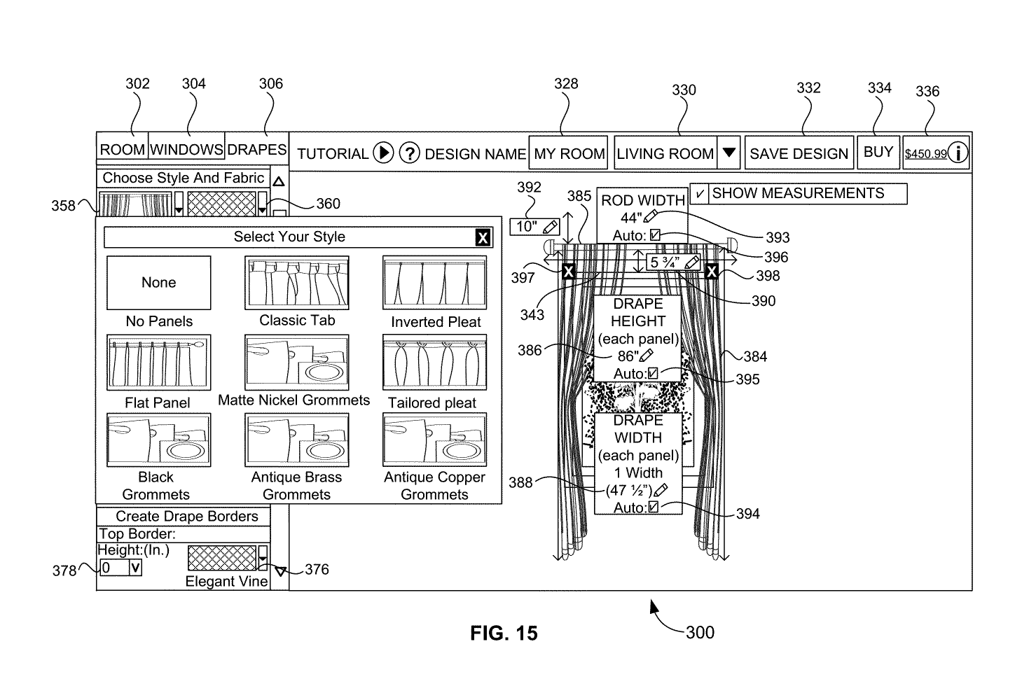

FIGS. 15-19 illustrate screen displays when the consumer selects menu items 358, 360, 366, 368, and 372, respectively. When one of menu items 358, 360, 366, 368, 372, 376, and 380 is selected, the menu item appears in an expanded form, with samples of the various drapery or curtain styles, drapery or curtain fabrics, linings, hardware, sheer options, and border fabrics being illustrated so that the consumer can select a desired option from each menu item.

There has been described a system and method for automated custom design of drapery and curtains. While several particular forms of the invention have been illustrated and described, it will be apparent that various modifications and combinations of the invention detailed in the text and drawings can be made without departing from the spirit and scope of the invention. Accordingly, it is not intended that the invention be limited, except as by the appended claims.

What is claimed is:

1. A method of automated custom design of draperies or curtains, comprising:
at a client computerized device, accessing through the internet a server computer that provides a design tool for designing draperies or curtains;
at the design tool, causing to be displayed at the client computerized device an image of a room;
at the client computerized device, selecting a location on the image of the room at which a window or door is to be displayed;
at the design tool, causing the window or door to be displayed on the image of the room at the client computerized device at the selected location;
at the client computerized device, selecting a drapery or curtain to be displayed on the image of the room;
at the design tool, causing the selected drapery or curtain to be displayed on the image of the room at the client computerized device in conjunction with the window or door.

2. A method in accordance with claim 1, further comprising:
at the client computerized device, selecting dimensions of the room; and
at the design tool, scaling the window or door and the drapery or curtain in the image of the room displayed at the client computerized device in accordance with the selected dimensions of the room.

3. A method in accordance with claim 2, wherein the design tool causes the drapery or curtain to be displayed on the image of the room in conjunction with the window or door with a pattern of the drapery or curtain scaled in accordance with the selected dimensions of the room.

4. A method in accordance with claim 1 wherein the design tool causes the image of the room to be displayed at the client computerized device with user-selectable text boxes containing dimensions so as to enable a user of the client computerized device to select dimensions by keying the dimensions directly into the image of the room displayed at the client computerized device.

5. A method in accordance with claim 1, comprising:
at the client computerized device, selecting a color of at least one of a wall, ceiling, floor, or molding of the room; and
at the design tool, causing the image of the room displayed at the client computerized device to be colored in accordance with the selected color.

6. A method in accordance with claim 1, further comprising:
at the client computerized device, selecting whether the image of the room includes a molding; and
at the design tool, causing the molding to be included or excluded in the image of the room displayed at the client computerized device in accordance with the selecting at the client computerized device of whether the image of the room includes the molding.

7. A method in accordance with claim 1, further comprising:
at the client computerized device, selecting a dimension of a molding of the room; and
at the design tool, scaling, on the image of the room displayed at the client computerized device, the molding in accordance with the selected dimension of the molding.

8. A method in accordance with claim 1 further comprising:
at the design tool, causing the client computerized device to display a menu of different types of windows or doors; and
at the client computerized device, selecting a window or door from the menu;
wherein the window or door displayed on the image of the room at the client computerized device at the selected location is the selected window or door.

9. A method in accordance with claim 1, comprising:
at the client computerized device, selecting dimensions of a window or door;
at the design tool, scaling the window or door in the image of the room at the client computerized device in accordance with the selected dimensions of the window or door.

10. A method in accordance with claim 1, comprising:
at the client computerized device, selecting a repositioned location of a window or door in the image of the room;
at the design tool, repositioning the window or door in the image of the room at the client computerized device in accordance with the repositioned location of the window or door.

11. A method in accordance with claim 1 wherein the design tool enables a user of the client computerized device to resize the window or door by dragging and dropping an edge of the window or door on the image of the room displayed at the client computerized device.

12. A method in accordance with claim 1, comprising:
at the client computerized device, selecting a window or door for removal from the image of the room;
at the design tool, causing the window or door to be removed from the image of the room at the client computerized device at the selected location.

13. A method in accordance with claim 1, further comprising:
at the design tool, causing the client computerized device to display a menu of different types background images to be seen through the window or door displayed on the image of the room at the client computerized device; and
at the client computerized device, selecting a background image from the menu;
wherein the window or door is displayed on the image of the room at the client computerized device together with the selected background image.

14. A method in accordance with claim 1, wherein the design tool causes a change in lighting within the image of the room at the client computerized device when the window or door is added to the image of the room at the client computerized device at the selected location, the change in lighting corresponding to passage of light through the window or door.

15. A method in accordance with claim 1, wherein the design tool causes a change in lighting within the image of the room at the client computerized device to change when the drapery or curtain is added to the image of the room in conjunction with the window or door, the change in lighting corresponding to blockage of light by the drapery or curtain.

16. A method in accordance with claim 1, wherein the design tool causes the drapery or curtain to be displayed on the image of the room at the client computerized device in conjunction with the window or door with dimensions of the drapery or curtain auto-sized based on the selected location of the window or door and dimensions of the window or door and the room.

17. A method in accordance with claim 1, further comprising:
at the client computerized device, selecting a value of at least one dimension of the drapery or curtain; and
at the design tool, causing the drapery or curtain to be displayed with the selected value of the dimension on the image of the room at the client computerized device.

18. A method in accordance with claim 17, further comprising:
at the client computerized device, re-selecting an altered value of the at least one dimension of the drapery or curtain, the re-selected altered value being different from the selected value; and
at the design tool, causing the drapery or curtain to be displayed with the re-selected altered value of the dimension on the image of the room at the client computerized device.

19. A method in accordance with claim 1, wherein the drapery or curtain comprises a left portion and a right portion, the method further comprising:
at the client computerized device, selecting one of the left and right portions for removal from the image of the room at the client computerized device; and
at the design tool, causing the image of the room to be displayed at the client computerized device with the selected portion of the drapery or curtain removed from the image of the room.

20. A method in accordance with claim 1, wherein the design tool auto-prices the drapery or curtain based on the selected drapery or curtain and the selected location at which the window or door is to be displayed.

21. A method in accordance with claim 1, wherein the design tool causes hardware for hanging the drapery or curtain to be displayed in conjunction with the drapery or curtain on the image of the room at the client computerized device.

22. A method in accordance with claim 21, wherein the design tool causes the hardware for hanging the drapery or curtain to be scaled in accordance with dimensions of the image of the room.

23. A method in accordance with claim 21, further comprising:
at the client computerized device, selecting a width of the hardware for hanging the drapery or curtain; and
at the design tool, causing the hardware to be displayed with the selected width on the image of the room at the client computerized device.

24. A method in accordance with claim 23, wherein the design tool auto-prices the drapery or curtain and the hardware based on the selected drapery or curtain, the selected location at which the window or door is to be displayed, and the selected width of the hardware.

25. A method in accordance with claim 1 further comprising:
at the design tool, causing the client computerized device to display a menu of different types of hardware for hanging the drapery or curtain;
at the client computerized device, selecting one of the different types of hardware from the menu; and
at the design tool, causing the selected hardware to be displayed in conjunction with the drapery or curtain on the image of the room at the client computerized device.

26. A method in accordance with claim 1, further comprising:
at the client computerized device, selecting whether an auto-pricing for the drapery or curtain includes hardware for hanging the drapery or curtain; and
wherein the design tool auto-prices the drapery or curtain and includes or excludes the hardware from the auto-pricing in accordance with the selecting at the client computerized device of whether the auto-pricing for the drapery or curtain includes the hardware.

27. A method in accordance with claim 1, further comprising:
at the client computerized device, selecting a dimension of at least one border of the drapery or curtain; and
at the design tool, causing the border of the drapery or curtain to be displayed with the selected dimension on the image of the room displayed at the client computerized device.

28. A method in accordance with claim 1, further comprising:
at the client computerized device, selecting a fabric of at least one border of the drapery or curtain; and
at the design tool, causing the border of the drapery or curtain to be displayed with the selected fabric on the image of the room displayed at the client computerized device.

29. A method in accordance with claim 1, further comprising:
at the client computerized device, requesting that sheer drapery be added to the image of the room displayed at the client computerized device; and
at the design tool, causing the sheer drapery to be added to the image of the room displayed at the client computerized device.

30. A method in accordance with claim 1, wherein the design tool provides a summary of parts required for installation of the drapery or curtain and provides sizes of the parts.

31. A method in accordance with claim 1, comprising:
at the client computerized device, requesting that the image of the room with the drapery or curtain be saved;
at the design tool, saving the image of the room with the drapery or curtain; and
at the client computerized device, retrieving the image of the room with the drapery or curtain.

32. A method in accordance with claim 1, comprising:
at the client computerized device, requesting a purchase of the drapery or curtain; and
at the design tool, initiating an online purchase of the drapery or curtain.

33. A system for automated custom design of draperies or curtains, comprising:
a client computerized device;
a server computer;
and a design tool for designing draperies or curtains, provided by the server computer upon access of the server computer by the client computerized device through the internet, the design tool being recorded in a non-transitory, tangible, machine-readable storage medium;
the design tool being programmed to cause to be displayed at the client computerized device an image of a room, and, upon selection at the client computerized device of a location on the image of the room at which a window or door is to be displayed, to cause the window or door to be displayed on the image of the room at the client computerized device at the selected location, and, upon selection at the client computerized device of a drapery or curtain to be displayed on the image of the room, to cause the drapery or curtain to be displayed on the image of the room at the client computerized device in conjunction with the window or door.

34. A design tool for designing draperies or curtains, recorded in a non-transitory, tangible, machine-readable storage medium, the design tool being provided by a server computer upon access of the server computer by a client computerized device through the internet, the design tool being programmed to cause to be displayed at the client computerized device an image of a room, and, upon selection at the client computerized device of a location on the image of the room at which a window or door is to be displayed, to cause the window or door to be displayed on the image of the room at the client computerized device at the selected location, and, upon selection at the client computerized device of a drapery or curtain to be displayed on the image of the room, to cause the drapery or curtain to be displayed on the image of the room at the client computerized device in conjunction with the window or door.
